(19) United States
(12) Patent Application Publication
(10) Pub. No.: US 2022/0205286 A1
(43) Pub. Date: Jun. 30, 2022

(54) DOOR PRESENTING DEVICE FOR A MOTOR VEHICLE DOOR ELEMENT

(71) Applicant: Kiekert AG, Heiligenhaus (DE)

(72) Inventors: Thorsten BENDEL, Oberhausen (DE); Uwe REDDMANN, Essen (DE)

(21) Appl. No.: 17/609,944

(22) PCT Filed: Apr. 28, 2020
(86) PCT No.: PCT/DE2020/100347

§ 371 Date: Nov. 9, 2021

(30) Foreign Application Priority Data
May 13, 2019 (DE) 10 2019 112 398.4

(51) Int. Cl. E05B 81/90; E05B 81/06; E05B 81/16; E05B 81/30; E05B 81/34; E05B 81/56; E05B 83/36; E05F 15/619; E05F 15/71; E05B 81/20; E05C 17/00

(52) U.S. Cl. CPC E05B 81/90; E05Y 2800/234; E05B 81/16; E05B 81/30; E05B 81/34; E05B 81/56; E05B 83/36; E05F 15/619; E05F 15/71; E05B 81/20; E05C 17/003; E05Y 2201/434; E05Y 2201/716; E05Y 2201/722; E05Y 2400/40; E05Y 2400/44; E05Y 2800/205; E05Y 2900/531; E05Y 2201/22; E05Y 2201/246; E05Y 2201/426; E05B 81/06

(57) ABSTRACT

A door presenting device for a motor vehicle door element, having an electric drive unit and an actuating means, wherein the actuating means can be adjusted by means of the drive unit and a gear mechanism arranged between the actuating means and the drive unit, with the result that a movement of the door element can be enabled, and further having a locking means. The door element can be maintained in position by means of the locking means and the locking means can be electrically actuated, namely indirectly, preferably manually, actuated.

The invention relates to a door presenting device for a motor vehicle door element, having an electric drive unit and an actuating means, wherein the actuating means can be adjusted by means of the drive unit and a gear mechanism arranged between the actuating means and the drive unit, with the result that a movement of the door element can be enabled, and further having a locking means. The door element can be maintained in position by means of the locking means and the locking means can be electrically operated.

Today's motor vehicles are increasingly being provided with convenience functions. For example, in order to make it easier to get into a motor vehicle and to be able to influence the aesthetic and aerodynamic shape, motor vehicles are equipped, for example, without an outer door handle. It is also conceivable, however, that an outside door handle is provided, but this only forwards a switching signal to the motor vehicle door latch to open it. In order to facilitate and automate getting into vehicles and, for example, to allow for getting into vehicles without handles on the outside of the door, so-called presenting devices or door presenting devices, some of which are also referred to as door openers, are used.

A positioner for motor vehicle doors or flaps, by which a door, flap or hood can be moved from a closed position into an open position, is known from DE 10 2011 015 669 A1. If the positioning apparatus relates, for example, to a motor vehicle side door, the door can be opened by means of an electrical pulse. For this, the locking mechanism of the door latch must first be unlocked, preferably electrically, so that the door can be opened. If, for example, the door sealing pressure is not sufficient to move the door from the closed position into an open position, the door can be moved into an open position by means of the positioning apparatus. An open position is defined here in such a way that the operator of the motor vehicle is able to grasp the door so that he can fully open the door. An electric drive unit is used as the positioning apparatus, which acts mechanically on the motor vehicle door in the form of a pivoting movement of the levers via a drive pawl and an inner and outer lever.

DE 10 2016 105 760 A1 discloses a presenting device for a motor vehicle door with a base plate, furthermore with a drive element mounted on the base plate and a drive unit, wherein a first sensor assigned to the drive element is provided which distinguishes at least between a presenting process and a manual opening process. The presenting device comprises a drive unit which can be driven via a sensor and a control unit. A flexible connecting means then allows for a transmission lever to be pivoted, which in turn allows for a presenting movement via a drive lever and a drive slide. In order to allow for the door to be moved, the drive slide moves linearly and, for example, out of an opening in a body so that an unlatched and unlocked door can be opened at least in some regions. The end position of the drive slide can be detected by means of a second stationary sensor, so that the drive unit can again be switched off.

From the applicant's unpublished patent application DE 10 2017 124 282.1, a presenting device for a motor vehicle door element has become known, comprising an electric drive unit and an actuating means, wherein the actuating means can be displaced by means of the drive unit and a gear mechanism arranged between the actuating means and the drive unit. The door can be moved by means of the presenting device, wherein a sliding element is arranged on the actuating means and interacts with a switching means so that the door movement can be detected. The actuating means is essentially formed from a driven toothed rack with an integrated sliding element, switching means and electrical supply line. By means of the switching means between the sliding element and the body, it is possible to control the movement of the driven toothed rack.

The generic state of the art is formed by the applicant's unpublished patent application (DE 10 2018 132 665.3). The document discloses a presenting device for a motor vehicle door element having an electric drive unit and an actuating means, wherein the actuating means is adjustable by means of the drive and a gear mechanism arranged between the actuating means and the drive, with the result that a movement of the door element can be made possible, and the presenting device also has a sensor for detecting the door movement, wherein the door element can be held by way of the actuating means. By means of a locking means, the presenting device is able to present the door element and to hold it in the presenting position. In addition, there is the possibility of moving the door element into a closed position by means of the presenting device.

The devices known from the state of the art have basically proven themselves, but then reach their limits if, for example, there is a power failure and the operator of the motor vehicle has to be able to open the door manually or if unintentional opening is to be prevented. This is where the invention starts from.

The object of the invention is to provide an improved presenting device for a motor vehicle door element. In addition, it is the object of the invention to provide a presenting device which enables emergency operation of the presenting device and is able to prevent unintentional opening. Finally, the object of the invention is to provide a structurally simple and inexpensive solution.

The object is achieved by the features of independent claim 1. Advantageous embodiments of the invention are specified in the dependent claims. It should be noted that the embodiments described below are not restrictive; rather, any variation possibilities of the features described in the description and the dependent claims are possible.

According to claim 1, the object of the invention is achieved in that a presenting device for a motor vehicle door element having an electric drive unit and an actuating means is provided, wherein the actuating means is adjustable by means of the drive unit and a gear mechanism arranged between the actuating means and the drive, with the result that a movement of the door element can be made possible, and a locking means, wherein the door element can be held by means of the locking means and the locking means can be operated electrically, and wherein the locking means can be operated indirectly, in particular manually. The construction of the presenting device according to the invention now creates the possibility of, on the one hand, securely holding the door element and, on the other hand, being able to unlatch it manually in the event of a power failure, for example. In an advantageous manner, the door element can consequently be safely moved and positioned, wherein the locking means can be operated indirectly and preferably manually.

If, for example, the motor vehicle door element is operated by an operator, for example by an outside door handle generating a signal to unlatch an electric latch, for example, and the presenting device receives a signal to open the door, the presenting device moves the motor vehicle door element into an open position in which the operator can grasp the open door and can open it fully. If, in this position of the motor vehicle door, there is now insufficient power available to electrically release the holding means or the locking means, then according to the invention there is the possibility of manually operating the presenting device and disengaging the locking means so that the door element can be moved independently of the presenting device. The presenting device only opens the door element to such an extent that it is possible for the operator to grasp the door element, but at the same time no unintentional opening beyond the open position takes place by means of the presenting device. There is thus a high level of safety that neither endangers people nor opens the door element itself into a danger area. However, indirect also means that a locking lever can be operated electrically by means of an aid, such as an actuating shaft, for example.

If, alternatively and for example, the motor vehicle door element is operated by an operator, for example by an inside door handle generating a signal to unlatch an electric latch, for example, and the presenting device receives a signal to open the door, the door element can be prevented from moving by means of the presenting device. Thus, for example, a child safety device can be displayed for the motor vehicle by means of the presenting device, with no additional components being required in the motor vehicle door element.

The presenting device is used in a motor vehicle door element. The motor vehicle door element can also be, for example, a flap, hood or cover, for example for a convertible roof. It may also be necessary to hold the component that is movably arranged on the motor vehicle, for example due to environmental influences, such as wind, in order to prevent unintentional opening. The presenting device can thus be used where a component that is movably arranged on the motor vehicle is to be positioned for further opening. In an advantageous manner, the presenting device cooperates with an electrically operable locking system, so that a high degree of constructive freedom can be made possible in the design of the door element. For example, the door element can dispense with a door handle, which results in almost any form of an outer shape of the door element.

The presenting device is usually arranged in the area of the door element in such a way that the door element can be positioned by operating the presenting device. The presenting device generates a relative movement between the body and the door element, wherein the presenting device is preferably arranged in the door element itself. An arrangement in the body for moving the door element is of course also conceivable. It is also conceivable that the presenting device is integrated into the motor vehicle latch, for example of a side door. This offers the advantage that an electrical voltage is available for the drive unit and/or that further functions in the motor vehicle latch can be operated by the drive unit.

The electric drive unit preferably consists of a direct current motor which interacts with an output shaft and, for example, with the actuating means via a worm gear. One-, two- or multi-stage gear mechanisms are conceivable, wherein the selection of the gear mechanism can influence the force available on the actuating means. If, for example, the presenting device is arranged in the door element in such a way that the presenting device interacts, for example, with an A-pillar of the motor vehicle and a front door, higher forces are necessary to present the door element than if the presenting device is again arranged in a front door of a motor vehicle and acts on a B-pillar in the motor vehicle. If a door is presented and the presenting device is arranged in the region of the motor vehicle latch, lower forces are required so that higher ratios can be used.

The electric drive unit enables the actuating means to move. By means of the electric motor it is possible to move the actuating means in such a way that the door can be opened by the driven actuating means. The actuating means moves relative to the body and exerts a compressive force on the vehicle door element, so that the unlatched and unlocked door can be moved.

The presenting device preferably interacts with a motor vehicle latch which has a catch and at least one pawl, wherein the locking mechanism comprising the catch and at least one pawl can preferably be unlocked electrically. In particular in the case of electrically unlockable closing systems, the operator of the motor vehicle only needs an electrical pulse to move the closing system into an unlocked, that is to say open, position. The closing system is then open so that the door or flap can be moved. The electrical opening pulse for the motor vehicle latch can be generated by means of a sensor, a key or, for example, a sensitive means such as, for example, a touch sensor or an outside door handle with an integrated sensor.

Once the vehicle door element is unlocked, the door element can be freely pivoted in the hinges. The door may also have a door retaining strap which can hold the door in several open positions. The door, once unlocked, can then be moved by means of the presenting device, wherein the movement of the vehicle door element is detectable by sensors. The entire presenting process is detected. A continuous detection takes place so that the door movement can be detected at any point in time of the movement of the vehicle door element by means of the presenting device. A door once manually moved beyond the movement of the presenting device disconnects the sensor detection in the presenting device, so that the electric drive unit can be switched off or the polarity of the electric drive unit can be reversed so that the actuating means can be moved back to its initial position. The detection of a manual movement of the vehicle door element is explained in detail below.

In one embodiment of the invention, the locking means has a locking lever, wherein the locking lever is manually pivotable. The use of a lever in the locking means offers the advantage that a lever effect and thus a translation is available in order to operate locking and unlocking of the locking means. With the presenting device, large forces can be transmitted, for example when heavy or stiff doors have to be operated. For example, there may be stiffness due to an iced door seal, for example. The door itself may also become stiff due to aging phenomena, for example. In addition, gripping the door by the operator can also exert an additional force on the presenting device. In all these cases, there can be high forces in the locking means which must be releasable by the drive unit of the locking means. The use of a locking lever offers the advantage that a favorable transmission ratio can be set in the lever, so that on the one hand secure locking, but also secure unlocking of the locking means can be guaranteed at any time. A pivotable mounting of the locking lever can thus be used in an advantageous manner for locking and unlocking the locking means. For example, the locking lever can engage in a locking contour on the motor vehicle body. The pivoting movement offers an easy way of providing secure engagement between the locking lever and the locking contour.

If the locking lever is electrically pivotable, in particular pivotable by means of a locking drive, a further embodiment variant of the invention results. The locking drive as well as the drive unit for the actuating means are connected to a control which enables the actuating means as well as the locking lever to interact. Depending on the control signal, which is sent to the controller by an operator using a radio remote control, for example, the lock can engage and provide an operative connection between the actuating means and a locking contour on the motor vehicle. After locking, the motor vehicle door can then be presented and held in one position by means of the electric drive unit for the actuating means. Depending on the case, a further control signal can then be passed to the locking means and in particular to the locking drive during the presenting, after the presenting position has been reached or also during closing, so that the locking mechanism can be unlocked. The separate electric drive unit thus creates the possibility of initiating unlocking at any point in time and thus providing the greatest possible flexibility for the operator of the motor vehicle.

A further advantageous embodiment variant of the invention results when the locking lever can be operated indirectly, in particular by means of an actuating shaft. An indirect actuation of the locking lever makes it possible to arrange the electrical locking drive in a stationary manner in the presenting device. The actuating means moves relative to the stationary actuating means drive and also to the stationary locking drive. By means of an actuating shaft that can be driven indirectly by the electrical locking drive, there is thus the possibility of providing remote operation of the locking lever. In addition, a transmission ratio can be created by means of the actuating shaft and engaging kinematics in the locking lever, so that secure locking and unlocking is possible even in extreme situations. Greater forces may have to be applied to the locking mechanism, for example, if, for example, an operator of the motor vehicle grabs the door that is already partially open and the operator wants to open the door completely. At this moment, the controller receives a signal, for example via the presenting device, so that unlocking can be initiated. At the time of unlocking, however, the force that the operator exerts on the door already acts on the locking mechanism and in particular on the locking lever. In order to be able to provide sufficient force for unlocking by the locking drive in this case as well, a stepped-up force can be introduced into the locking lever by means of the actuating shaft, so that the transmission ratio in the actuating shaft is available for reliable unlocking of the locking means.

Another embodiment variant of the invention results when an operating lever is provided and the operating lever is in operative connection with the actuating shaft. An operating lever enables the operator of the motor vehicle to manually release the presenting device. The operating lever can be arranged in a stationary manner in the presenting device. If, for example, there is a power failure or power drop, so that no sufficient energy supply can be made available to unlock the presenting device, then emergency operation can take place by means of the operating lever. A point of application of the operating lever on the actuating shaft can advantageously reduce the number of components required to a minimum.

The operating lever can advantageously be operated electrically, which results in a further embodiment of the invention. An electrical operation of the operating lever enables the operating lever to perform a double function. On the one hand, the operating lever can be used manually for unlocking in an emergency and at the same time the operating lever can serve as a drive means for the locking drive. If the locking drive accesses the operating lever and ultimately the actuating shaft, the number of components can be reduced and, at the same time, a favorable lever arrangement with a favorable lever torque for actuating the locking lever can be provided. For example, the operating lever can be fastened on the actuating shaft and can have a toothing into which a gear wheel, for example arranged on the output shaft of the locking drive, engages. Electrical locking and unlocking as well as manual emergency unlocking can thus be provided with a minimal number of components.

In a further embodiment, the operating lever and the locking drive are in operative connection by means of a gear mechanism. By coupling of the operating lever to the locking drive via a gear mechanism, a favorable transmission ratio can be set for the drive unit. In particular, there is thus the possibility of being able to use a motor with a low output, which in turn has an advantageous effect on the costs of the presenting device. In addition, the actuating time for the locking lever can be influenced via the gear mechanism, so that very short actuating times can also be implemented in the drive unit for the locking lever. Another embodiment variant of the invention results when the actuating shaft is accommodated in the actuating means in a displaceable manner. A relative movement between the actuating shaft and the actuating means can be made possible by a displaceable mounting of the actuating shaft in the actuating means. The actuating shaft is stationary and is preferably accommodated and mounted in the operating lever and extends into the actuating means. A further mounting point for the actuating shaft can be arranged in the actuating means itself, wherein the mounting point can be arranged in a stationary manner in the actuating means. Thus, during adjustment of the actuating means, the electric drive unit causes a relative movement between the actuating shaft and the actuating means. The actuating shaft remains continuously in engagement with the locking lever, so that the locking means can be unlocked at any time. The actuating shaft can be received non-rotatably on one side in the operating lever and can be mounted in the operating lever. In addition, of course, there is also the possibility that the actuating shaft is mounted in the region of the operating lever and forms a bearing point for the operating lever. In an advantageous manner, the operating lever can thus be operated via the locking drive and the gear mechanism, whereby the actuating shaft is rotated. The actuating shaft itself can be in direct engagement with the locking lever or can pivot the locking lever by means of an operating means. The operating means can advantageously be designed as a sliding element and can be in engagement with the actuating shaft. The sliding element can then be displaced by the rotary movement of the actuating shaft, and the locking lever can be operated. In an advantageous embodiment variant, the sliding element is guided in a linearly displaceable manner in the actuating means and in particular in the interior of the actuating means. If the locking lever is also arranged in a recess or in an interior of the actuating means, a structurally favorable embodiment of the presenting device can be provided. By an arrangement of the sliding element and the locking lever in the interior of the actuating means, the adjusting means can function independently of external weather conditions. This enables the presenting device to have a long service life and also ensures a high level of functionality of the presenting device and, in particular, functionality of the locking means even under extreme weather conditions, such as frost and/or humidity.

If an actuation of an inside door handle can be detected by means of the control unit, with a signal of the actuation of the inside door handle being able to be evaluated to control the presenting device, a further advantageous embodiment variant of the invention results. On the one hand, an opening signal for the door element can take place by means of a radio remote control, for example, but there is also the possibility that an occupant of the vehicle operates an inside door handle, whereby the presenting device receives a signal to move the door element into an open position. If, in this case, the inside door handle is provided with a child safety device and this is switched on, a child safety device can be displayed by means of the presenting device. A latch functionality can thus be implemented by means of the presenting device and opening of the door element can be prevented. For this purpose, the locking lever can be brought into engagement with the locking contour, wherein the drive unit of the presenting device functions as a brake in this case. Unintentional opening or unauthorized opening can consequently be prevented.

In a further embodiment variant of the invention, a movement of the door element can be detected by means of a movement and/or environment sensor, wherein a signal from the movement sensor and/or environment sensor can be evaluated to control the presenting device. Advantageously, further sensors in or on the motor vehicle can also be integrated into the functionality of the presenting device. The presenting device and the further sensors are electrically connected to one another, for example via a control integrated in the motor vehicle or a separate control assigned to the door element, for example. If an obstacle, for example, is detected by means of a further sensor, the control can send a signal to the presenting device and, for example, can initiate locking of the presenting device. In this way, presentation of the door element can be prevented and/or delayed, for example. If, for example, an approaching cyclist is detected by means of an environment sensor, the opening or moving of the door element can be prevented by means of the presenting device. On the one hand, opening can be prevented, but there is also the possibility of stopping the door element while the door element is moving, in order to prevent a possible collision, for example. On the other hand, it is possible to prevent the door element from being released. If, for example, the door element that is already in the open position is gripped by the operator to open it and another sensor detects an obstacle, the door element can be prevented from being released, wherein the locking lever remains in the locked position, for example. By integration of the further sensors in the presenting device, a further increase in the security of the installation device can be achieved and a further increase in functionality can be represented.

It can also be advantageous and can represent an embodiment variant of the invention if at least one further electric drive unit is provided for moving the door element. The presenting device, which can also be referred to as the door opening device, moves the door element into a presenting position in which the door element can be gripped by the operator and can be opened completely. In addition, a door drive, that is to say an electric drive unit for moving the door element into a completely open position, can be installed in the motor vehicle. A fully automatic opening of the door element can be made possible in the interaction of the presenting device and the door drive. In this case, the presenting device can in turn serve as a safety device in order to prevent the door element from being braked or opened if, for example, another sensor detects an obstacle or a child safety device is inserted. By locking of the presenting device, a means for actively intervening in the opening process can be provided, at least in relation to the travel of the presenting device, and thus the highest degree of safety can be achieved.

In the following, the invention is explained in more detail with reference to the appended drawings using an exemplary embodiment. However, the principle applies that the exemplary embodiment does not limit the invention, but merely represents an embodiment. The features shown can be implemented individually or in combination with further features of the description as well as the claims, individually or in combination.

In the drawings:

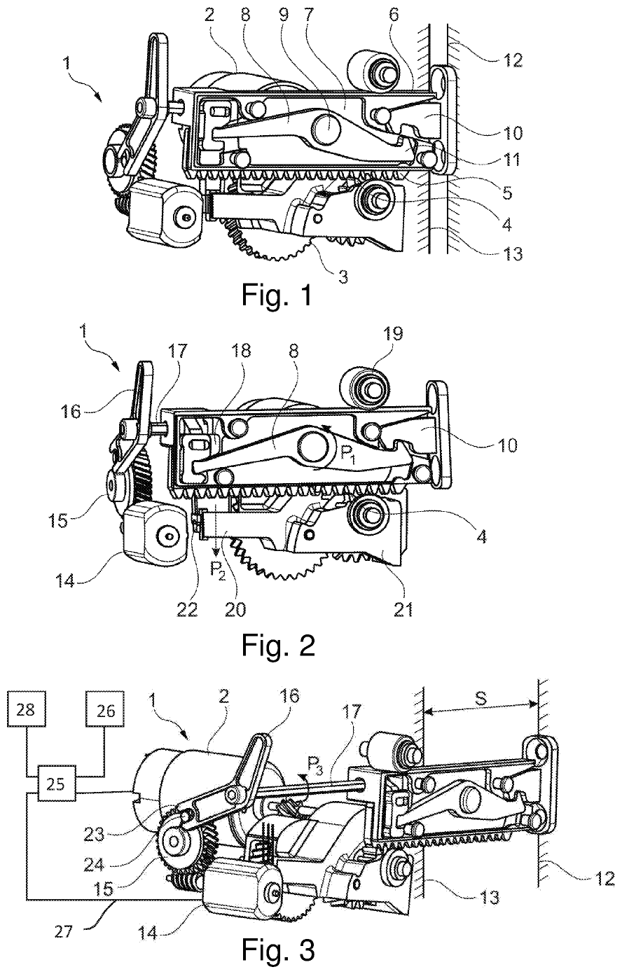

FIG. 1 is a three-dimensional view of a presenting device in an initial position, i.e. a closed motor vehicle door element in the unlocked state,

FIG. 2 is a three-dimensional view of the presenting device according to FIG. 1, wherein the locking lever is shown in a locked position, and

FIG. 3 again is a three-dimensional view of the presenting device according to FIGS. 1 and 2, wherein the actuating means is shown extended, i.e., FIG. 3 shows the position of the actuating means in a presenting position of the motor vehicle door element, wherein the motor vehicle door element is held in the presenting position by means of the locking means.

In FIG. 1, a three-dimensional view of a presenting device 1 is reproduced. The presenting device 1 comprises an electric drive unit 2, and a gear mechanism 3 connected downstream of the electric drive unit 2, wherein the gear mechanism 3 is in engagement with a toothed rack 5 by means of a gear wheel 4. The toothed rack 5 in turn forms part of the actuating means 6 and is firmly connected to the actuating means 6. A locking lever 8 is accommodated in a pivotable manner in the interior 7 of the actuating means 6. The locking lever 8 is pivotable about an axis 9 and can be brought into form-fitting engagement with a locking contour 10. A hook-shaped end 11 engages in the locking contour 10. Of course, other forms of a form-fitting and/or force-fitting connection between the locking lever 8 and the locking contour 10 are also conceivable according to the invention. In this embodiment, the locking contour 11 is screwed and thus firmly connected as a separate component to the body of the motor vehicle. The basic structure of the electric drive unit 2 and the interaction of the electric drive unit 2 with the gear mechanism 3 and the actuating means 6 is described in the generic state of the art according to DE 10 2018 132 665.3, this part of the description of the state of the art is explained in full in relation to the content of the disclosure of the application.

The actuating means 6 is shown in an initial position, wherein the actuating means is shown in the position where it is completely retracted into the motor vehicle door element 13. The motor vehicle door element 13 is consequently closed and the presenting device is out of operation.

If an operator of the motor vehicle transmits a signal to the presenting device 1 that the door is to be presented, a gear mechanism 15 is activated by means of a locking drive 14, whereby an operating lever 16 is moved. The operating lever 16 pivots an actuating shaft 17, wherein the actuating shaft 17 moves a sliding element 18 in the interior 7 of the actuating means 6, whereby the locking lever 8 is pivoted about the axis 9 in the direction of the arrow P1. The locking lever 8 comes into engagement with the locking contour 10, so that the motor vehicle door element 13 can be safely guided and presented.

The presentation of the motor vehicle door element 13 is thus also safely possible when, for example, external influences act on the motor vehicle door element. If the motor vehicle is, for example, on a sloping road and/or stormy wind movements also act on the motor vehicle door element, the presenting device can be used to ensure that the motor vehicle door element 13 is guided safely at all times. The motor vehicle receives a control signal from the operator that the motor vehicle door element 13 is to be opened. The control signal causes, on the one hand, an electrical unlocking of a motor vehicle latch, the presenting device 1 preferably interacting with an electrically unlockable motor vehicle lock, so-called electric locks. The unlocked latch releases a locking mechanism so that the locked actuating means can open the door 13. During the presentation, the actuating means is guided between the gear wheel and a guide means 19.

The locked state of the presenting device 1 is shown in FIG. 2.

FIG. 3 shows the presenting device 1 in a presenting position of the motor vehicle door element 13. The actuating means 6 has been moved completely out of the motor vehicle door element 13 by means of the drive unit 2, wherein an actuating path S is shown in FIG. 3. The locking lever 8 is still in engagement with the locking contour 10, so that the motor vehicle door element 13 is securely held in the presenting position. If the motor vehicle door element 13 is now gripped, for example by the operator of the motor vehicle, an extension 20 of the gear mechanism carrier 21 pivots in the direction of the arrow P2 in FIG. 2. The movement of the extension 20 of the gear mechanism carrier 21 can be detected by means of the sensor 22, whereby a control signal can be transmitted to the locking drive 14 by means of the controller.

A control signal for the locking drive 14 causes the locking drive 14 to pivot the operating lever 16 via the gear mechanism 15. In this exemplary embodiment, the operating lever 16 and the gear mechanism 15 are in operative connection by means of a recess 23 and a cylindrical pin 24 arranged on a gear wheel of the gear mechanism 15. The pivoting of the operating lever 16 causes the actuating shaft 17 to be rotated in the direction of the arrow P3, as a result of which the sliding element 18 pivots the locking lever 8 about the axis 9 and thus disengages the locking lever 8 from the locking contour 10. The motor vehicle door element 13 can be opened manually and the actuating means 6 is returned to the motor vehicle door element 13.

If, for example, in the position of the motor vehicle door element 13, as shown in FIG. 3, there is no adequate power supply available for the locking drive 14, the operating lever 16 can be grasped, for example through an opening in a door panel, and can release the locking lever 6 from the engagement with the locking contour 10. It is of course also conceivable that the operating lever 16 is connected to a Bowden cable, for example, so that the operating lever 16 can be operated remotely.

A control unit 25 which can also be seen in FIG. 3 is electrically connected, on the one hand, to the presenting device 1 and, on the other hand, to a further sensor 26. The control 25 is connected by means of a connecting line 27 to the electric drive units 2, 14 of the presenting device 1 and also, for example, to an inside door handle 28. The control 25 can be a control 25 of the motor vehicle or else a control 25 inside the door, which is assigned, for example, to the presenting device 1 and/or a latch or is part of the presenting device 1 itself. By means of the control unit 25, it is possible to connect the functions of the further sensors 26 and the inside door handle 28, but also to connect them to a control signal from an operator of the motor vehicle. In this combination, it is thus possible, on the one hand, to initiate a normal presentation or, on the other hand, to display further functions by means of the further sensors.

If, for example, the inside door handle 28 is now operated, wherein a child safety device is switched on at the same time by the operator of the motor vehicle in relation to the inside door handle 28, the presenting device 1 can prevent the opening process. To prevent the opening, the locking lever 8 can be brought into engagement with the contour 10, wherein a braking effect can be introduced into the door element 13 by means of the electric drive unit 2. In this case, the presenting device 1 serves as a child safety device.

Even in the case of manual opening, movement of the door element 13 can be prevented by means of the presenting device 1 in order, for example, to provide an anti-theft device. In the representation of these extended functions of the presenting device 1, it is advantageous that no additional components are required in the door element and/or in the latch.

### LIST OF REFERENCE SIGNS

1 presenting device
2 electric drive unit
3,15 gear mechanism
4 gear wheel
5 toothed rack
6 actuating means
7 inside of the actuating means
8 locking lever
9 axis
10 locking contour
11 hook-shaped end
12 body
13 motor vehicle door element
14 locking drive
16 control lever
17 actuating shaft
18 sliding element
19 guide means
20 extension
21 gear mechanism carrier
22 sensor
23 recess
24 cylindrical pin
25 control
26 movement sensor, environment sensor
27 connecting line
28 inside door handle
P1, P2, P3 arrow
S control path

1. A presenting device for a motor vehicle door element, the presenting device comprising:
an electric drive unit;
an actuator, wherein the actuator is configured to be adjusted by the drive unit and a gear mechanism arranged between the actuator and the electric drive unit, with the result that a movement of the motor vehicle door element is enabled; and
a lock, wherein the motor vehicle door element is configured to be held via the lock and the lock is configured to be operated electrically, wherein the lock is configured to be operated indirectly.

2. The presenting device according to claim 1, wherein the lock has a locking lever, wherein the locking lever is pivotable manually.

3. The presenting device according to claim 2, wherein the locking lever is configured to be pivoted electrically.

4. The presenting device according to claim 2, wherein the locking lever is configured to be operated indirectly.

5. The presenting device according to claim 4 further comprising an operating lever, wherein the operating lever is in operative connection with the actuating shaft.

6. The presenting device according to claim 5, wherein the operating lever is configured to be operated electrically.

7. The presenting device according to claim 5, wherein the operating lever and a locking drive are in operative connection by another gear mechanism.

8. The presenting device according to claim 5, wherein the actuating shaft is accommodated in the actuator in a displaceable manner.

9. The presenting device according to claim 1, wherein a sliding element, is in engagement with an actuating shaft.

10. The presenting device according to claim 9, wherein the sliding element is guided in the sliding element so as to be linearly displaceable.

11. The presenting device according to claim 1, wherein the presenting device is configured to be controlled by a control unit.

12. The presenting device according to claim 11, wherein operation of an inside door handle is detectable by the control unit, wherein a signal of the operation of the inside door handle is evaluated to control the presenting device.

13. The presenting device according to claim 1, wherein a movement of the motor vehicle door element is detectable via a movement sensor and/or environment sensor, wherein a signal from the movement sensor and/or environment sensor is evaluated to control the presenting device.

14. The presenting device according to claim 1 further comprising at least one further electric drive unit for moving the door element.

15. The presenting device according to claim 3, wherein the locking lever is configured to be pivoted by a locking drive.

16. The presenting device according to claim 4, wherein the locking lever is configured to be operated by an actuating shaft.
